(19) United States
(12) Patent Application Publication
(10) Pub. No.: US 2009/0257807 A1
(43) Pub. Date: Oct. 15, 2009

(54) KEYBOARD HAVING A BACK-TO-BACK POSITION

(75) Inventor: GREGORY B. WOLOSCHYN, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/100,258

(22) Filed: Apr. 9, 2008

(51) Int. Cl. B41J 5/10

(52) U.S. Cl. 400/489

(57) ABSTRACT

A keyboard that includes at least two planes of keys and a communication port. The keyboard can be configured to include a back-to-back position. In the back-to-back position, the planes can be jointed so that each plane has outwardly facing keys which are fixed relative to the other plane at approximately a one-hundred and eighty degree angle (e.g., between one hundred and seventy degrees and one hundred and eighty degrees) relative to the other plane. The communication port can establish a communication linkage between the keyboard and a computing device. When in the back-to-back position, key presses from the keyboard are able to be conveyed across the communication linkage to be interpreted as input by the communicatively linked computing device.

### BACKGROUND OF THE INVENTION

The present invention relates to the field of keyboard devices, more particularly, to an optionally repositionable keyboard having a back-to-back position.

Mobile devices have become an increasing trend in consumer electronics. Portable media players, mobile phones, mobile computers, and the like have become common among consumers. The way users interact with these mobile devices can vary significantly, but their input requirements can be the same. For example, mobile phones can require the input of both text and numbers, but commonly mobile phones only implement a keypad. Inputting text on a keypad can become troublesome and time consuming. Some devices can implement a touch screen, which can be used in conjunction with an on-screen keyboard. Other devices even implement a miniature keyboard.

There is one common problem with these input solutions: the inability to type quickly. When users are mobile, there are situations that can require quick access to information on a portable device. Input restrictions can prevent quick access to data on a mobile device. A more intuitive solution is needed for improved mobile input efficiency. A device is needed in which can provide a well-known keyboard standard, while still being mobile.

### BRIEF SUMMARY OF THE INVENTION

One aspect of the present invention can include a keyboard having two planes of keys and a communication port. The keyboard can be configured to include a back-to-back position. In the back-to-back position, the planes can be jointed so that each plane has outwardly facing keys which are fixed relative to the other plane at approximately a one-hundred and eighty degree angle (e.g., between one hundred and seventy degrees and one hundred and eighty degrees) relative to the other plane. The communication port can establish a communication linkage between the keyboard and a computing device. When in the back-to-back position, key presses from the keyboard are able to be conveyed across the communication linkage to be interpreted as input by the communicatively linked computing device.

Another aspect of the present invention can include a method for utilizing a keyboard. In the method, a keyboard having a back-to-back position can be identified. In the back-to-back position two planes of keys can be jointed so that each plane has outwardly facing keys which are fixed relative to the other plane at approximately a one-hundred and eighty degree angle relative to the other plane. The keyboard can be positioned between two hands so that the inward portion of the hands face one another with the keyboard having the back-to-back position being in between the two hands. Keys on opposing sides of the keyboard can be pressed using fingers on the hand nearest the outwardly facing keys. The key presses can be accepted as input by a computing device communicatively linked to the keyboard.

Still another aspect of the present invention can include a method for configuring a repositionable keyboard. In the method, a keyboard having a set of usable positions can be identified. The usable positions can include first position and a second position. The keyboard can be utilized in the first and second positions, wherein key presses are interpreted as input by a communicatively linked computing device when the keyboard is in either the first or second positions. The keyboard can be manipulated to reconfigure it between the first and second positions. The first position can be a back-to-back position and the second position can be an approximately flat position.

### BRIEF DESCRIPTION OF THE SEVERAL VIEWS OF THE DRAWINGS

FIG. 1 is a schematic diagram of a system of a keyboard device in accordance with an embodiment of the inventive arrangements disclosed herein.

FIG. 2 illustrates scenarios for using a keyboard having a back-to-back configuration in accordance with an embodiment of the inventive arrangements disclosed herein.

FIG. 3 is a flow chart of a method for using a mobile repositionable keyboard having a back-to-back configuration in accordance with an embodiment of the inventive arrangements disclosed herein.

### DETAILED DESCRIPTION OF THE INVENTION

The present invention can include a mobile repositionable keyboard. This keyboard can be split into individual parts. One such embodiment can include the keyboard being split directly in the center, to allow the repositioning (or folding) of the keyboard in half. Although this can be the preferred embodiment and is shown in the diagrams, the present invention can be split up into any number of individual parts.

One significant position for the keyboard is to position the keyboard sections back-to-back with keys facing outwards on each side. A user can position his hands to cup this keyboard (in a modified praying position) and can use this keyboard configuration in a space constrained situation. In one embodiment, the back-to-back keyboard need not be position-able, but can instead be a fixed keyboard implementation. The back-to-back keyboard can be used without a supporting surface, as a user's hands applied in opposing directions provide sufficient support. Advantageously, keys can be arranged in a “standard” QWERTY fashion, so that skilled typist can leverage their existing skills when using the back-to-back keyboard. In various embodiments, support and slide structures can be included with the back-to-back keyboard to facilitate its use. The repositionable (and fixed back-to-back) keyboard can optionally include a pointing device.

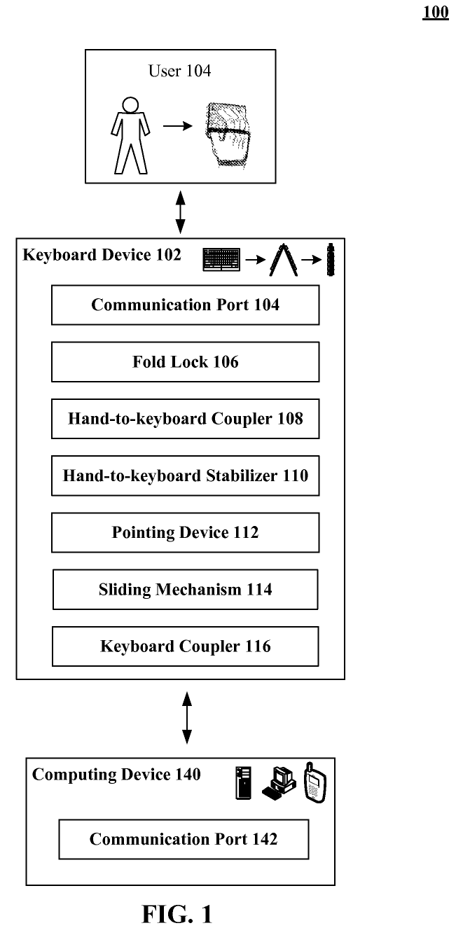

FIG. 1 is a schematic diagram of a system 100 of a keyboard device 102 in accordance with an embodiment of the inventive arrangements disclosed herein. User 104 can interact with keyboard device 102 to interface with computing device 140. In one embodiment, the keyboard device 102 can have a QWERTY layout (e.g., US-International layout, UK-Extended Layout, etc.) of keys of sufficient size and spacing to permit touch typing. Other embodiments for other layouts (Dvorak, Colemak, etc.) can also be accommodated by system 100.

One novel configuration of keyboard device 102 is a split keyboard configuration in which two halves of a keyboard are positioned back-to-back with outwardly facing keys. This is a usable configuration of device 102, where a user 104 can utilize it while it is cupped between his/her hands, each hand having access to half of the available keys. A hand-to-keyboard coupler 108 and/or a hand-to-keyboard stabilizer 110 can exist to permit a user's hands relative to the keyboard device 102 to remain in a type-able position.

While the keyboard device 102 can be a fixed device having a back-to-back or approximately back-to-back positioning, it can also be a repositionable device. This repositionable (foldable or otherwise detachable) device can have two or more usable positions. For example, the device can be used in a traditional “flat” position, in a back-to-back position, or in intermediary positions (such as when folded at a forty-five degree angle with outward facing keys. A keyboard coupler 116 can be used to join different potions of the keyboard together to create these different usable positions. A fold lock 106 can be used to lock the keyboard device in a user selected intermediary position (e.g., at a forty-five degree angle, at a sixty-degree angle, etc.). In one embodiment, two halves of a separable keyboard device 102 can be decoupled and used while in a decoupled state. For example, one half of a keyboard can rest on a right armrest of a chair and another rest on a left armrest of the chair, while the separated keyboard is still usable.

In various configurations, the keyboard device 102 can also include an optional pointing device 112, which functions as mouse, trackball, track point, track pad, and the like. A wireless and/or wired communication port 104 can permit the device 102 to communicate with computing device 140. Further, when keyboard device 102 is permitted to be decomposed into two or more usable segments, each segment can have a communication port 104 (e.g., wireless transceiver) for communicating to the other segment and/or for communicating with computing device 140.

As used herein, computing device 140 can be any computing device capable of interfacing with keyboard device 102. Commonly, computing device 140 can be a mobile computing device, such as a PDA (personal data assistant), POCKET PC, mobile phone, or the like. Computing device 140 can also be a stationary device, such as a laptop computer, a workstation computer, a server computer, and the like.

Communication ports 142 and 104 can be used to establish communication between keyboard device 102 and computing device 140. Communication ports 104 and 142 can employ any communication protocol and can be wired or wireless. Communication ports 104 and 142 can be implemented to conform to USB, serial, BLUETOOTH, WIFI, PS/2, WIRELESS USB, RF, and other standards.

In one embodiment, the keyboard device 102 can be an input accepting device having distinct keys for each letter of an alphabet and each number. Keys can also exist for a space bar, an enter button, shift, control, alt, and other such keys. The keyboard device 102 can conform to numerous standards, which include a QUERY standard, QUERTY extensions, and the like. Thus, although the keyboard device 102 is able to be split into two distinct sides (one for each hand), it is nevertheless a “full” or “compact” keyboard having a standard set of keys, which can be pressed using standard key presses of learned typists. When the keyboard is folded or split, the split occurs along “standard” typing regions. For example, after being split (assuming a QUERTY keyboard), a left hand can be associated with keys of:

top row—12345;

next row—<tab> qwert;

next row—<Caps Lock> asdfg;

next row—<shift> zxcvb;

next row—<ctrl> <OS key> <alt> <space >.

After split a right hand can be associated with keys of:

top row—67890-=<backspace>;

next row—yuiop[ ]\;

next row—hjkl;'<enter>;

next row—bnm,./<shift>;

next row—<space> <alt> <OS key> <ctrl>.

In another embodiment, the keyboard device 102 can be a special purpose keyboard with key mappings specific to an electronic game or set of electronic games. In another embodiment, this keyboard device 102 can include an accelerometer and other components to detect a movement of the entire keyboard device 102 in space, especially when positioned in a back-to-back embodiment.

Hand-to-keyboard coupler 108 can be any object or device that can keep user 104's hand attached to keyboard device 102. Hand-to-keyboard coupler 108 can be implemented as wrist straps. These wrist straps can implement any attachment device, including, but not limited to, VELCRO, buttons, snap attachment devices, and the like.

Hand-to-keyboard stabilizer 110 can be any object or device that can stabilize keyboard device 102 when being used by user 104. In certain situations when keyboard device 102 is in use, it is contemplated that it can be troublesome to keep keyboard device 102 anchored and/or stabilized for efficient typing. Hand-to-keyboard stabilizer 110 can be implemented as, but is not limited to, a counterweight, counterbalance, or the like. Hand-to-keyboard stabilizer 110 can be omitted in certain embodiments, but can be any object to provide the functionality described.

Sliding mechanism 114 can be a mechanism that can allow sections of keyboard 102 to slide. Sliding mechanism 114 can allow the sliding of each section individually, or even smaller portions of each section to slide individually. Sliding mechanism 114 can be implemented in any way to include the described functionality. For example, sliding mechanism 114 can include ball bearings and rails for each keyboard section to slide.

Keyboard coupler 116 can be the device or object that can join the individual sections of keyboard device 102. Keyboard coupler 116 can allow keyboard device 102 to fold, slide, magnetically join, or otherwise reposition along the joint created by keyboard coupler 116. In some embodiments, keyboard coupler 116 can allow the decoupling of each section of keyboard device 102. Keyboard coupler 116 can allow the communication between each keyboard section. In the case that keyboard coupler 116 can allow the decoupling of keyboard device 102, it is contemplated that keyboard coupler 116 can make use a communicator (not shown) to communicate with the other keyboard sections wirelessly. Keyboard coupler 116 can be implemented in any way, including, but not limited to, using magnetized metals, using a hinge connector, or the like.

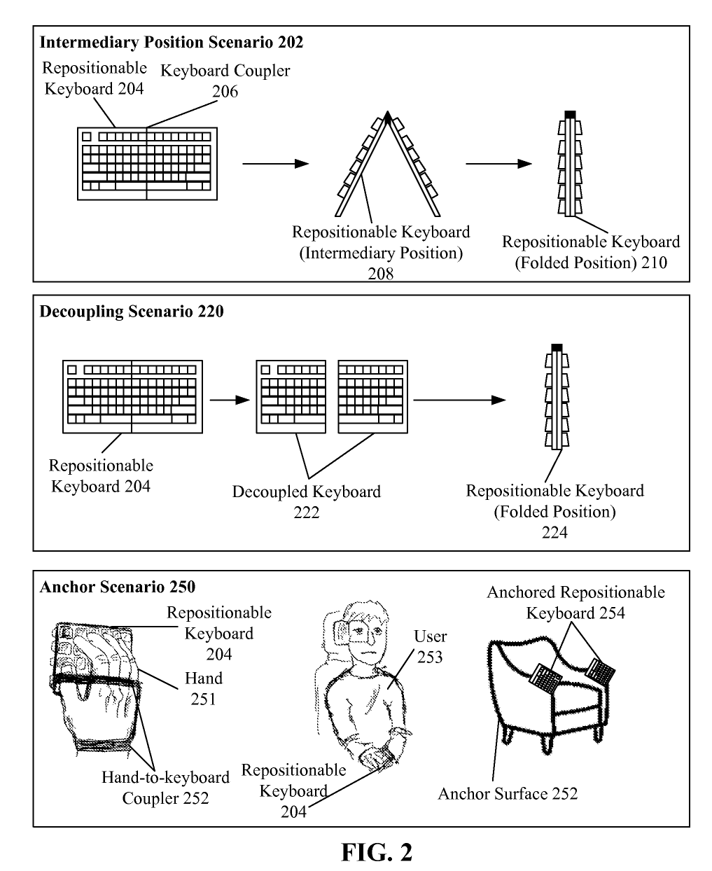

FIG. 2 illustrates scenarios 202, 220, 250 for using a keyboard having a back-to-back configuration in accordance with an embodiment of the inventive arrangements disclosed herein. The scenarios include: an intermediary position scenario 202, a decoupling scenario 220, and an anchor scenario 250. These are not intended to be exhaustive, but are intended to illustrate concepts expressed herein. The scenarios 202, 220, 250 can be performed in context of system 100 or any approximately equivalent system.

Intermediary position scenario 202 can illustrate a repositionable keyboard 204 being folded along its keyboard coupler 206 into intermediary position 208. One folded into intermediary position 208, a lock mechanism can be used to keep repositionable keyboard 204 in its position. Intermediary position scenario 202 can also illustrate repositionable keyboard 204 being folded into folded position 210 from intermediary position 208. Folded position 210 can illustrate a maximum position repositionable keyboard 204 can be folded. Position 210 represents a back-to-back position in which press-able keys are positioned within two planes in opposing outwardly facing directions. The intermediary position 208 can be a usable position of the keyboard 204. The optional fold lock mechanism can permit intermediary position 208 to be fixed so that the two key containing planes are at any angle from zero to one hundred and eighty degrees from each other.

Decoupling scenario 220 can illustrate a repositionable keyboard 204 being decoupled into decoupled keyboard 222. Decoupled keyboard 222 can include two individual parts that can be used separately. The individual parts of decoupled keyboard 222 can convey the input they receive to each other and/or to a centralized component that aggregates the key presses. In some embodiments, one part can act as a communicator, which can convey the input to the device the keyboard is connected to. In this embodiment, the other individual parts would convey input they receive to the communicator. As shown, decoupled keyboard 222 can be reattached in a folded state (or reattached, then folded) to create folded position 224. The decoupled keyboard 222 can be mounted or affixed to a support structure, such as shown by illustration 254. Coupling the discrete section in foldable position 224 can utilize any coupling technology, such as magnetic coupling, hook-and-loop fastening, buttoning or snap based coupling, coupling by sliding one extruded section into a matching groove, utilizing a suction cup coupling, etc.

Anchor scenario 250 illustrates several anchor scenarios. For example, repositionable keyboard 204 is shown attached to hand 251 with hand-to-keyboard coupler 252. In this example, repositionable keyboard 204 can be anchored to hand 251. This anchoring can occur discretely for each hand, or can occur jointly causing two hands to cup the keyboard 204 having a back-to-back configuration (e.g., in a modified praying position or a position with palms facing each other and the keyboard 210 positioned in between the palms). User 253 is shown in a position where he/she can interact with repositionable keyboard 204 with both hands, using each opposing hand as an anchor supporting the other. In yet another example, anchored repositionable keyboard 254 can be anchored to anchor surface 252. Anchor surface 252 as shown can be a chair. Anchored repositionable keyboard 254 can be a decoupled repositionable keyboard 204. Each individual part of anchored repositionable keyboard 254 can be attached to each arm rest of anchor surface 252. This anchoring is not limited to arm rests and can occur with any stable surface able to serve as an anchor. Further, anchoring using a stable surface can be used with any scenario 202, 220. For example, a support member can attach to a center of a keyboard in intermediary position 208 to support the keyboard against a desktop or other horizontal surface.

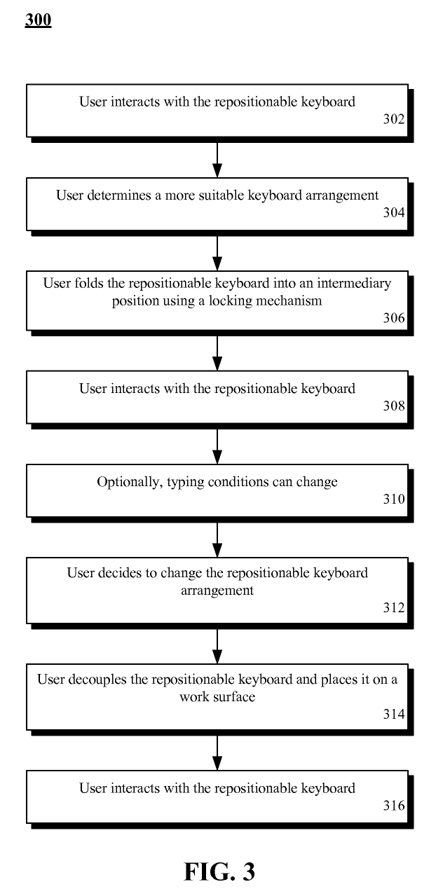

FIG. 3 is a flow chart of a method 300 for using a mobile repositionable keyboard having a back-to-back configuration in accordance with an embodiment of the inventive arrangements disclosed herein. Method 300 can be performed in context of system 100.

Method 300 can begin with step 302, where the user can interact with the repositionable keyboard. The user can interact with the repositionable keyboard in an initial state or configuration. In step 304, the user can determine a more suitable keyboard arrangement. For example, the user can determine that folding the keyboard in half and placing it in a back-to-back position would be more efficient. The user can also choose to fold the keyboard in an intermediary position, or to attempt one or more intermediary positions to determine one which is appealing. In step 306, the user can fold the repositionable keyboard into an intermediary position using a locking mechanism. In step 308, the user interacts with the repositionable keyboard in its intermediary position. In step 310, optionally, typing conditions can change. For example, the user can switch their environment in which they'd like to type (i.e. the user took a train to work and has arrived). In step 312, the user can decide to change the repositionable keyboard arrangement. The condition change in step 310 can influence the decision the user makes in step 312. In step 314, the user can decouple the repositionable keyboard and can place it on a work surface. In step 316, the user can interact with the repositionable keyboard in the decoupled state on a work surface.

It should be appreciated that not every keyboard is able to be decoupled, folded, or otherwise repositioned. A fixed keyboard in a back-to-back position should be considered within scope of the present invention. Also, folding and decoupling are not necessarily mutually exclusive embodiments, as indicated by method 300. That is, a single implementation of a keyboard can permit folding, locking in an intermediate position, creating a back-to-back configuration, and decoupling into two or more discrete (and usable) keyboard planes.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A keyboard comprising:
two planes of keys, wherein said keyboard is configured to include a back-to-back position, wherein in said back-to-back position said planes are jointed so that each plane has outwardly facing keys which are fixed relative to the other plane at approximately a one-hundred and eighty degree angle relative to the other plane; and
a communication port configured to establish a communication linkage between the keyboard and a computing device, wherein when in said back-to-back position, key presses from said keyboard are able to be conveyed across the communication linkage to be interpreted as input by the communicatively linked computing device.

2. The keyboard of claim 1, wherein the approximately one-hundred and eighty degree angle comprises angles from one hundred and seventy degrees to one hundred and eighty degrees.

3. The keyboard of claim 1, further comprising:
a hand-to-keyboard coupler configured to keep a user's hands attached to the keyboard such that one hand is positioned to utilize keys on one of the planes in the back-to-back position and the other hand is positioned to utilize keys on the other one of the planes.

4. The keyboard of claim 1, further comprising:
a pointing device configured to positioning a cursor on a computer screen.

5. The keyboard of claim 1, wherein said planes are able to be configured in a plurality of usable positions, one of which is the back-to-back position.

6. The keyboard of claim 1, wherein one of the usable positions comprises an approximately flat position, wherein said plurality of planes are positioned to lie substantially flat on a horizontal surface with keys of the planes being pressed though motions approximately orthogonal to the horizontal surface.

7. The keyboard of claim 6, further comprising:
a fold lock configured to lock said keyboard in any of a plurality of intermediary positions, wherein said intermediary positions are usable keyboard positions, wherein said fold lock permit locking in at least one position where an angle of one plane relative to the other is between ten and one hundred and seventy degrees.

8. The keyboard of claim 1, wherein said keyboard comprises individual keys for all the letters of an alphabet, for all numeric digits, for a space bar, for an enter key, and for a shift key.

9. The keyboard of claim 8, wherein each of the two planes of keys corresponds to a particular hand of a typist, wherein an arrangement of the keys in each plane is identical to a standardized layout of keys with respect to the hand for which that plane corresponds.

10. The keyboard of claim 1, wherein said keyboard comprises a QWERTY layout of keys, wherein each of the two planes of keys corresponds to a particular hand of a typist, wherein an arrangement of the keys in each plane is a QWERTY layout of keys with respect to the hand for which that plane corresponds.

11. The keyboard of claim 10, wherein said keys are of a sufficient size and spacing to permit touch typing by an average standard adult sized hand.

12. The keyboard of claim 11, further comprising:
a hand-to-keyboard coupler configured to keep a user's hands attached to the keyboard such that one hand is positioned to utilize keys on one of the planes in the back-to-back position and the other hand is positioned to utilize keys on the other one of the planes.

13. The keyboard of claim 11, wherein said plurality of planes are able to be configured in a plurality of usable positions, one of which is the back-to-back position, and wherein another one of the usable positions is an approximately flat position, wherein when in the approximately flat position said planes are positioned to lie substantially flat on a horizontal surface with keys of the planes being pressed though motions approximately orthogonal to the horizontal surface.

14. A method for utilizing a keyboard comprising:
identifying a keyboard having a back-to-back position, wherein in said back-to-back position two planes of keys are jointed so that each plane has outwardly facing keys which are fixed relative to the other plane at approximately a one-hundred and eighty degree angle relative to the other plane;
positioning said keyboard between two hands, so that the inward portion of the hands face one another with the keyboard having the back-to-back position being in between the two hands; and
pressing keys on opposing sides of the keyboard using fingers on the hand nearest the outwardly facing keys, wherein said key presses are accepted as input by a computing device communicatively linked to said keyboard.

15. The method of claim 14, further comprising:
coupling said hands to said keyboard using a hand-to-keyboard coupler.

16. The method of claim 14, wherein said keyboard comprises individual keys for all the letters of an alphabet, for all numeric digits, for a space bar, for an enter key, and for a shift key, wherein each of the two planes of keys corresponds to a particular hand of a typist, wherein an arrangement of the keys in each plane is identical to a standardized layout of keys with respect to the hand for which that plane corresponds.

17. The method of claim 14, wherein said keyboard comprises a QWERTY layout of keys, wherein each of the two planes of keys corresponds to a particular hand of a typist, wherein an arrangement of the keys in each plane is a QWERTY layout of keys with respect to the hand for which that plane corresponds, and wherein said keys are of a sufficient size and spacing to permit touch typing by an average standard adult sized hand.

18. A method for configuring a repositionable keyboard comprising:
identifying a keyboard having a plurality of usable positions, comprising a first position and a second position;
utilizing the keyboard in the first position, wherein key presses are interpreted as input by a communicatively linked computing device when the keyboard is in the first position;
manipulating the keyboard from the first position to a second position;
utilizing the keyboard in the second position, wherein key presses are interpreted as input by a communicatively linked computing device when the keyboard is in the second position, wherein said first position comprises a back-to-back position and wherein the second position comprises an approximately flat position, wherein in the back-to-back position two planes of keys are jointed so that each plane has outwardly facing keys which are fixed relative to the other plane at approximately a one-hundred and eighty degree angle relative to the other plane, and wherein in the approximately flat position said two planes planes are positioned to lie substantially flat on a horizontal surface and wherein the two planes are coupled together, and wherein the keys of the two planes being configured to be pressed though motions approximately orthogonal to the horizontal surface, wherein said keyboard comprises a QWERTY layout of keys, wherein each of the two planes of keys corresponds to a particular hand of a typist, wherein an arrangement of the keys in each plane is a QWERTY layout of keys with respect to the hand for which that plane corresponds.

19. The method of claim 18, further comprising:
manipulating the keyboard from at least one of the first and second positions to a third position;
utilizing the keyboard in the third position, wherein key presses are interpreted as input by a communicatively linked computing device when the keyboard is in the third position, wherein the two planes of keys of said keyboard are hinged to each other, wherein the third position is one in which the angle between the two planes is between twenty and one hundred and sixty degrees, wherein the manipulating of the keyboard locks the keyboard in the third position.

20. The method of claim 18, further comprising:
manipulating the keyboard from at least one of the first and second positions to a third position;
utilizing the keyboard in the third position, wherein key presses are interpreted as input by a communicatively linked computing device when the keyboard is in the third position, wherein the two planes of keys are decoupled completely from one another in said third position.
